(19) United States
(12) Patent Application Publication
(10) Pub. No.: US 2006/0239210 A1
(43) Pub. Date: Oct. 26, 2006

(54) Subsystem for cartographic analysis of analysis data with a view to optimizing a communications network

(75) Inventors: Jean-Roch Houllier, Saint-Michel sur Orge (FR); Alain Brethereau, Viroflay (FR); Eric Brigant, Velizy-Villacoublay (FR); Beatrix De Mathan, Paris (FR); Antoine Landrault, Rambouillet (FR)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S.

(21) Appl. No.: 11/396,576

(22) Filed: Apr. 4, 2006

(30) Foreign Application Priority Data
Apr. 6, 2005 (FR) 0503410

(51) Int. Cl. H04L 12/28; H04Q 7/00

(52) U.S. Cl. 370/254; 370/329

(57) ABSTRACT

A subsystem for use in a system (OO) for optimizing and/or managing and/or supervising a communications network including network elements (C1-C3) with known geographical positions through which passes traffic defined locally by analysis data is dedicated to analyzing analysis data (D). The system comprises, firstly, an interface (I) adapted to select, firstly, network elements (Ci), secondly, an analysis to be effected on selected analysis data relating to said selected network elements and, thirdly, a type of analysis result, and, secondly, analyzer means (MA) adapted to effect each selected analysis on said selected analysis data taking account of the respective positions of said selected network elements and to deliver in a cartographic form analysis results conforming to said selected type, with a view to use thereof by said network optimization and/or management and/or supervision system (OO).

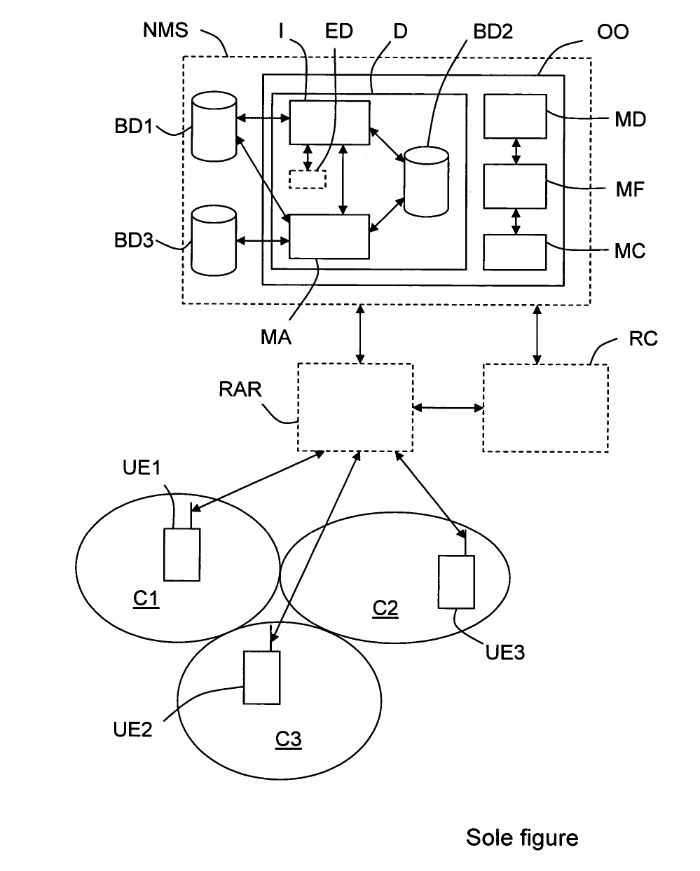

### BACKGROUND OF THE INVENTION

The invention relates to communications networks and more particularly to optimizing and managing or supervising communications network operation and/or configuration.

Given the deployment and operating costs of communications networks, it is important for operators frequently to optimize the operation and/or configuration of their networks, in order to make the best possible use of the network communications resources, given in particular service level agreements entered into with their users, and/or to enable network densification or expansion. In the case of mobile or cellular radio networks, the communications resources, i.e. radio channels, constitute an important constraint, in particular by virtue of the fact that their re-use can cause interference.

To optimize a network, and thus to manage the utilization of its resources, analysis data must be made available, for example traffic data defining the traffic in transit through the network elements, or network parameters or indicators, for example quality of service (QoS) indicators.

In the present context, the expression “traffic data” refers to values of parameters or indicators that can be measured or estimated by a network management system (NMS) and the expression “network element” refers to any physical and/or logical component of a network through which passes traffic defined locally by parameter or indicator values, for example a cell in which mobile terminals can set up or continue calls or a network equipment such as a router or a base station.

The person skilled in the art is aware that managing the network parameters (or indicators) is a difficult and complex task and, moreover, an ongoing task in the case of network expansion and/or densification. It necessitates the use of a network optimization system (or tool), for example the Radio Network Optimization (RNO®) system developed by ALCATEL for cellular radio networks. A network optimization system is used to monitor the quality of service in certain network elements, for example cells, to diagnose causes of problems, in particular quality of service problems, to propose solutions to those problems, and to define sets of objects (also known as “object zones”) as a function of criteria such as belonging to a given geographical area, for example, in order to track and study quality of service within at least some sets of objects.

In the present context, the term “object” refers to a physical network element, for example a cell, or a logical network element, for example an adjacency relationship defined on the basis of a movement from one cell to another. Additional information on these sets of objects (“object zones”) can be found in French Patent Application FR 04 53275 in particular.

The level of optimization offered by existing network optimization systems is limited by the fact that they manage only some of the parameters involved in the use of the resources (for example, they take no account of the impact of the behavior of users and offer only cartographic analysis, often only a minor analysis).

### SUMMARY OF THE INVENTION

An object of the invention is therefore to improve on this situation, in particular in the case of radio communications networks.

To this end it proposes a subsystem dedicated to analyzing analysis data for use in a system for optimizing and/or managing and/or supervising a communications network including network elements with known geographical positions through which passes traffic defined locally by analysis data.

This analyzer subsystem is characterized in that it comprises:
an interface adapted to select, firstly, network elements, secondly, an analysis to be effected on selected analysis data relating to the selected network elements and, thirdly, a type of analysis result, and
analyzer means adapted to effect each selected analysis on the selected analysis data taking account of the respective positions of the selected network elements and to deliver in a cartographic form analysis results conforming to the selected type, with a view to use thereof by the network optimization and/or management and/or supervision system.

The analyzer subsystem of the invention may have other features, and in particular, separately or in combination:
its interface may be adapted to define an analysis geographical area containing the selected network elements, for example;
the analysis geographical area may be defined as a function of a selected criterion, for example a criterion of belonging to an area of predefined geometry within a region or a criterion of belonging to an environment of a selected type within a region;
its analyzer means may be adapted to effect each selected analysis on the selected analysis data relating to all the network elements contained in the analysis geographical area;
it may further comprises first storage means for storing data representing the geographical positions of the network elements; in this case, its analyzer means may be adapted to access the first storage means to extract position data for the selected network elements with a view to effecting the analyses on the selected analysis data;
it may further comprise second storage means for storing data defining analyses; in this case, its analyzer means may be adapted to access the second storage means to extract data defining at least some of the selected analyses with a view to effecting those analyses on the selected analysis data;
its interface may be adapted to define at least some of the selected analyses and/or new analyses, for example;
the analyses include in particular analysis of convergence and/or divergence of analysis data relative to reference data, analysis of the adequacy and/or inadequacy of capacities of network elements as a function of observed traffic, analysis of interference between adjacent network elements, analysis of use of network elements relative to a territory, and traffic flow analysis;
some analysis results may be delivered in the form of a list of objects for defining or refining sets of objects (“object zones”).

The invention also proposes a network optimization and/or management and/or supervision system equipped with an analyzer subsystem of the kind described above.

The network optimization and/or management and/or supervision system may be adapted to display analysis results delivered by the analyzer subsystem to enable their visual use and/or to define or refine sets of objects (“object zones”) grouping each of the network elements on the basis of the analysis results delivered by the analyzer subsystem and/or to diagnose causes of problems occurring in the communications network from analysis results delivered by the analyzer subsystem.

The invention is particular well adapted, although not exclusively so, to radio communications networks, in particular of cellular (or mobile) type. It relates generally to any type of communications network, including switched landline networks (better known as the “plain old telephone service” (POTS) and public switched telephone networks (PSTN)), as well as cable local area networks (LAN) and wireless local area networks (WLAN).

### BRIEF DESCRIPTION OF THE DRAWINGS

Other features and advantages of the invention will become apparent on reading the following detailed description and examining the appended drawing, the single FIGURE whereof is a functional block diagram of a cellular communications network equipped a network optimization and/or management and/or supervision system including one embodiment of an analyzer subsystem of the invention. The appended drawing constitutes part of the description of the invention and may, if necessary, contribute to the definition of the invention.

### DETAILED DESCRIPTION OF THE INVENTION

An object of the invention is to make cartographic analysis data available for optimizing the operation and/or configuration of a communications network and thereby optimizing the use of its communications resources.

The communications network considered below is a cellular (or mobile) cellular radio network such as a GSM network, a GPRS/EDGE network, a UMTS network or a WiMax network, for example. Consequently, the resources considered here are radio channels. However, the invention is adapted to any type of communications network and in particular to switched landline networks (POTS or PSTN), cable local area networks (LAN), and wireless local area networks (WLAN).

Very broadly speaking, but nevertheless in sufficient detail for the invention to be understood, and as shown in the FIGURE, a cellular radio network may be summarized as consisting of a switching network (also called the core network) RC coupled to a radio access network RAR (called the UTRAN in a UMTS network and the BSS in a GSM network), itself connected to a network management system (NMS).

The radio access network RAR includes base stations (a base station is called a Node B in a UMTS network or a base transceiver station (BTS) in a GSM network) and either radio network controllers or nodes (RNC) in a UMTS network or base station controllers (BSC) in a GSM network connected to each other and to an access network manager. The base stations are also connected to the network management system NMS via the radio network controllers.

Each base station (Node B or BTS) is associated with one or more cells Ci each covering a radio area in which mobile terminals UEj can set up (or continue) radio connections.

In the present context, the expression “mobile terminal” refers to any mobile or portable communications terminal capable of exchanging data in the form of radio signals either with another terminal or network equipment via their parent network or networks or with its own parent network, for example mobile telephones and fixed or portable computers or personal digital assistants (PDA) equipped with a radio communications module.

In the present example, three cells (C1-C3, i=1 to 3) are shown. However, i can take any non-zero value. Moreover, in the present example, three mobile terminals (UE1-UE3, j=1 to 3) are shown. However, j can take any non-zero value.

The switching network RC includes network equipments connected to the radio network controllers RNC or base station controllers BSC, a network manager and a network management system NMS.

For optimizing the use of the communications resources of the (cellular) radio network, the network management system NMS includes (or is coupled to) a network optimization and/or management and/or supervision system (or tool) 00, for example the RNO® system referred to in the introduction.

The invention proposes an analyzer subsystem D for analyzing analysis data and adapted to feed cartographic analysis results to the network optimization and/or management and/or supervision system (or tool) 00. In the embodiment shown, which is not limiting on the invention, the analyzer subsystem D is a processor system integrated into the network optimization and/or management and/or supervision system (or tool) 00.

The analysis data analyzer subsystem D of the invention includes a man/machine interface I and a module MA dedicated to analyzing selected analysis data.

As indicated in the introduction, in the present context the expression “analysis data” refers to traffic data, network parameters, and indicators, for example quality of service indicators. Also, in the present context, the expression “traffic data” refers to values of parameters or indicators that can be measured or estimated by the network management system NMS. Moreover, in the present context, the expression “network element” refers to any physical and/or logical network component through which passes traffic defined locally by parameter or indicator values, for example a cell Ci in which mobile terminals UEj can set up or continue calls or a network equipment such as router or a base station (BTS or Node B).

According to the invention, the user uses the interface I to perform at least three kinds of selection: network element selection, selection of one or more analyses to be effected on selected analysis data relating to the selected network elements, and selection of one or more types of analysis result.

Network element selection is preferably the first operation effected, for which purpose the interface I must access data representing the geographical positions of the various network elements. That data may consist of network element identifiers stored in corresponding relationship to relative or absolute two-dimensional or three-dimensional positions or more simply identifiers of network element whose relative or absolute two-dimensional or three-dimensional positions are known, at least approximately.

This geographical position data is stored in first storage means BD1 which may take any form, for example a database or a memory. As shown in the single FIGURE, the first storage means BD1 are generally installed in the NMS. This is not obligatory, however. They could in fact be installed in the network optimization and/or management and/or supervision system OO or in the analyzer subsystem D.

Selection may be effected in various ways.

One way is for the user to select each network element in a list displayed on a screen or in a region displayed on a map representing at least a portion of the network.

Another way is for the user to define an analysis geographical area containing the selected network elements using the interface I. Any type of definition may be envisaged.

Thus the user may supply coordinates defining an area on a displayed map indicating at least a portion of the network.

The interface I may instead make available to the user areas of predefined shape, for example squares or circles. In this case, the user must indicate the location of the area of selected shape on a displayed map representing at least a portion of the network, where applicable with the characteristic dimension or dimensions of that area.

Another option is for the user to define an analysis geographical area as a function of one or more selected criteria. The criteria that may be used include, for example, the criterion of belonging to an area of predefined geometry within a region displayed on a map representing at least a portion of the network. In this case, the region displayed may be divided beforehand into areas from which the user makes a selection (the user may select one or more areas), or the user can indicate to the analyzer subsystem D the place on the map where to place the centre of the area(s) that is to be selected. Another example of a criterion that may be used is one of belonging to an environment of a selected type within a region displayed on a map representing at least a portion of the network. In this case, the user supplies to the interface the type of environment required and the interface takes charge of determining the areas of the region displayed that correspond to the specified type of environment. The environment types include, for example, urban environments, where appropriate dense urban environments, rural environments, where applicable mountainous rural environments, and suburban environments, and more generally any type of environment that may be characterized by one or more selection criteria based, for example, on geographical, geo-marketing, parameter or network topology criteria. In this situation, the first storage means BD1 or other dedicated storage means store definitions of areas as a function of environment types as defined above.

When an area is selected (or defined), all the network elements that are inside that area are preferably selected. This is not obligatory, however. In fact the interface I could display on a screen all the network elements situated inside the area selected (or defined) in order for the user to be able to select at least some of them.

Analysis selection is preferably effected after network element selection. Selection may be effected from a list of predefined analyses and/or using parameters defining each required analysis (the user can in particular create analyses, where appropriate by combining geographical, geo-marketing, parameter and network topology criteria).

When the selection is made at least in part from a list, the interface I must access data defining various predefined analyses. That data may consist of simple identifiers designating analyses that the user is deemed to know or parameters whose values are fixed or to be fixed.

The data defining the analyses is stored in second storage means BD2 which can take any form, for example a database or a memory. As shown in the single FIGURE, the second storage means BD2 are preferably installed in the analyzer subsystem D. This is not obligatory, however. They could in fact be installed in the optimization and/or management and/or supervision system OO or in the NMS.

When selection is effected at least in part by means of parameters, an editor ED coupled to the interface I may be made available to the user, for example.

As shown in the single FIGURE, the editor ED may be installed in the analyzer subsystem D. This is not obligatory, however. It could in fact be installed in the optimization and/or management and/or supervision system OO or in the NMS.

In this case, the user defines each analysis using the editor ED, for example by providing each parameter and its associated value(s). The interface I then recovers each analysis definition and forwards it to the analyzer module MA.

When it is obligatory for a selected analysis to relate to one or more types of analysis data, the user does not have to specify the analysis data that will have to be analyzed by the analyzer module MA. On the other hand, when a selected analysis may relate to one or more data types that depend on circumstances, the user must specify the analysis data that will have to be analyzed by the analyzer module MA.

Any type of analysis data analysis may be envisaged.

These analysis types include in particular analyses of convergence and/or divergence of analysis data relative to reference data. This first analysis example consists in comparing operational values of logical parameters of network elements (for example cells Ci) to reference values in order to determine their respective proximity (in terms of difference) to said reference values.

Mention may also be made of analyses of the adequacy and/or inadequacy of the capacities of network elements as a function of observed traffic or of values of certain parameters or indicators. This second analysis example consists in comparing the declared capacities of network elements (for example cells Ci) to traffic values or the values of certain parameters or indicators that are measured (or estimated) at the network element level (as a function of the “land usage” class), for example by means of one or more quality of service indicators, in such manner as to determine their respective levels of adequacy.

Mention may equally be made of analyses of interference between adjacent network elements. This third example of analysis consists, for example, in comparing the frequencies used by each selected network element (for example each cell Ci) to the frequencies used by the adjacent network elements, allowing for frequency hopping and where appropriate for the type of interference (for example cochannel or adjacent channel interference), in such manner as to determine any interference areas.

Mention may equally be made of analyses of use of network elements relative to a land usage class. This fourth example of analysis consists, for example, in associating each selected network element (for example each cell Ci) with the land usage class (or to another typology—or characteristic of the area—of a geographical or geo-marketing kind, for example) corresponding to its location. For example, a cell may be characterized as a function of the type of communications network that passes through it (national roads, regional roads, motorways, rivers, railways) and/or another land usage characteristic (for example a commercial area, a business area or a domestic area).

Traffic flow analyses may equally be mentioned. This fifth example of analysis consists, for example, in studying the various traffic streams observed in an area, allowing for adjacency relationships declared and available in that area, to determine adjacency relationships as a function of observed traffic.

The types of analysis mentioned above are not limiting on the invention. The analyses may be either predefined or defined by the user as a function of requirements.

The result type(s) are preferably selected after selecting the analyses and any associated analysis data and generally depend on the selected analysis. However, for a given analysis there may more than one way to present its results. In this case, the interface I can display a list of predefined analysis result types on the screen for the attention of the user. To this end, the interface I must access data defining various predefined analysis result types. That data may be simple identifiers designating analysis result types that the user is deemed to know or parameters whose values are fixed or to be fixed. The data defining the analyses is stored in the second storage means BD2, for example. Thus the user has only to select the type of analysis result required for each analysis that has been selected (the user may have to select parameter values).

Any type of cartographic result corresponding to an analysis may be envisaged.

Accordingly, in the case of the first example of analysis given above, a convergence and/or divergence map may be delivered, for example, highlighting the greater or lesser proximity (in terms of difference) of each selected network element parameter value relative to the corresponding reference value, for example by means of different shades of grey or different combinations of colors.

In the second example of analysis described above, an adequacy and/or inadequacy map may be delivered, for example, highlighting the greater or lesser proximity of each selected network element as a function of observed traffic and associated land usage areas or other criteria by means of different shades of grey or different combinations of colors.

In the third example of analysis described above, an interference map may be delivered, for example, highlighting areas in which interference may occur, and where applicable indicating the type of interference (cochannel interference or adjacent channel interference).

In the fourth example of analysis described above, a map may be delivered, for example, showing the cells (for example) differently according to the land usage class in which they fall (or according to any other classification). The user can in particular select the number of classes and their types. For example, a map can show cells crossed by a major road or a major railway and situated 200 meters or less from a commercial area.

In the fifth example of analysis described above, a map may be delivered, for example, highlighting the various adjacency relationships as a function of observed traffic.

Once the selections have been completed, the interface I forwards the definitions and/or designations thereof to the analyzer module MA.

According to the invention, the analyzer module MA carries out each analysis selected by the user by means of the interface I. To do this, it must first access:
the first storage means BD1, to extract data on the positions of the network elements selected by the user, the identifiers whereof have been communicated to it via the interface I,
the second storage means BD2, to extract data that defines at least some of the analyses selected by the user, the identifiers whereof have been communicated to it via the interface I; if a selected analysis is not listed in the second storage means BD2, because it was defined by the user (for example using the editor ED), then the parameters defining that analysis are communicated to the analyzer module MA via the interface I, and
third storage means BD3 that store the network analysis data, to extract analysis data that corresponds to the analyses selected and/or defined by the user.

The third storage means BD3 may take any form, for example a database or a memory. The third storage means BD3 are generally installed in the NMS, as shown in the single FIGURE.

Once the analyzer module MA is in possession of all the above-mentioned data, it can carry out each analysis selected by the user on the selected analysis data, taking account of the respective positions of the selected network elements and the selected result type.

The results of each analysis are then delivered to the optimization and/or management and/or supervision system (or tool) OO by the analyzer module MA in a cartographic form, i.e. linked to the geographical positions of the selected network elements and to the list of those network elements.

Some of these analysis results may be delivered in the form of lists of objects intended, for example, for defining or refining sets of objects (“object zones”) or for producing diagnostics.

The network optimization and/or management and/or supervision system OO can then use the cartographic analysis results.

At least three types of use may be envisaged.

A first type relates to visual use of the cartographic analysis results by the user. In this case, the network optimization and/or management and/or supervision system OO has access to a data display module MF including a screen (for example a computer screen) enabling it to display a map showing cartographic analysis results.

A second type of use relates to defining or refining sets of objects (“object zones”) on the basis of cartographic analysis results delivered by the analyzer subsystem D.

Remember that in the present context the expression “set of objects” refers to a group of network elements (network objects) satisfying one or more selected criteria. In other words, the network objects satisfying that criterion or those criteria are selected to constitute a set of objects. The possible criteria include, for example, those based on radio configuration parameters, those based on quality of service indicators (and in particular on a traffic model, where applicable a “basic” model), those based on network topology parameters, those based on cell characteristics, those based on parameters of neighbor (adjacency) relationships between cells, those of geo-marketing type, those of geographical type, and those of temporal type.

Moreover, in the present context the expression “traffic model” refers to any model representing traffic (voice and/or data traffic) that is changing in terms of telecommunications volume and/or relating to the manner in which a call associated with the traffic proceeds, for example the duration of a call, at the level of a network element. In other words, a traffic model constitutes a traffic signature at the network element level. Moreover, in the present context the expression “basic traffic model” refers to a model representing a traffic type and generally intended to be compared to a traffic model and the expression “traffic type” refers to traffic characteristics of a geographical area or an environment. For example, basic traffic models may be defined respectively corresponding to traffic in residential areas, business areas and commercial centers.

For defining or refining sets of objects, the network optimization and/or management and/or supervision system OO includes a definition module MC storing the definitions of the basic traffic models and responsible for comparing the (measured) traffic models, corresponding to network elements, to basic traffic models, in order to constitute sets of objects.

The cartographic analysis results may be used automatically by the definition module MC to refine definitions of sets of objects, where appropriate as a function of instructions given by the user after said results are displayed by the data display module MF.

These results may also be viewed by the user on the data display module MF in order to develop a strategy for defining or refining sets of objects and then instruct the definition module MC to define or refine one or more sets of objects, taking account of instructions and where applicable of cartographic analysis results.

This type of use is facilitated if the analyzer module MA delivers analysis results in the form of lists of objects, as previously indicated.

A third type of use relates to the production of diagnoses of causes of problems occurring in the communications network.

As the person skilled in the art is aware, diagnostic tools have been created to determine the causes of problems occurring in communications networks, for example degraded quality of service.

Some diagnostic tools use diagnostic trees to determine causes of problems. A diagnostic tree is a structure consisting of nodes each associated with one or more network tests and linked by branches representing logical relations between tests, known as causality relations. The leaves (or terminals) of a diagnostic tree correspond to particular causes of problems (causes explaining the origin of a problem), the parent nodes of the leaves correspond to the causes of those particular causes, and so on up to the root node of the tree, which corresponds to a root cause corresponding to the root problem to be explained.

To determine each particular cause at the origin (root) of a problem, the diagnostic tree that corresponds to that problem is considered from its root node to one or more of its leaf nodes. The results of the tests defined at each node are deemed to enable each cause of a problem to be determined precisely, in order to be able to remedy it effectively.

Other diagnostic tools are based on the use of Bayesian networks. A Bayesian network is a causality tree consisting of branches (or links) respectively associated with complementary probabilities and having nodes designating basic (or elementary) tests to be effected.

For producing diagnostics, the network optimization and/or management and/or supervision system OO includes a diagnostic module (or tool) MD, for example a module of one of the above-mentioned types.

The cartographic analysis results delivered by the analyzer subsystem D may be either compared to the results of a diagnosis to attempt to find a match between them or fed to the diagnostic module (or tool) MD for it to determine network elements causing problems and attempt to find the cause(s) of the problem(s).

If the analyzer module MA delivers analysis results in the form of lists of objects, those lists may be used automatically by the diagnostic module (or tool) MD to execute certain diagnostics for each object (or element) that they contain, where applicable in the event of crossing a threshold.

Depending on the embodiment of the network optimization and/or management and/or supervision system 00, it may include a data display module MF, a module MC for defining sets of objects and/or a diagnostic module MD.

The analyzer subsystem D of the invention, and in particular its analyzer module MA, its interface I, its storage means BD1 and/or BD2, if any, and its editor ED, if any, may take the form of electronic circuits, software (or electronic data processing) modules, or a combination of circuits and software.

The cartographic analysis results may also be used as input to other analysis functions, for example quality of service analysis and comparison of scheduled values and operational values of parameters or indicators.

The invention is not limited to the analyzer subsystem and network optimization and/or management and/or supervision system embodiments described above by way of example only, and encompasses all variants that a person skilled in the art might envisage that fall within the scope of the following claims.

What is claimed is:

1. A subsystem for analyzing analysis data (D) for use in a system (OO) for optimizing and/or managing and/or supervising a communications network including network elements (Ci) with known geographical positions through which passes traffic defined locally by analysis data, which system is characterized in that it comprises:
an interface (I) adapted to select, firstly, network elements (Ci), secondly, an analysis to be effected on selected analysis data relating to said selected network elements and, thirdly, a type of analysis result, and
analyzer means (MA) adapted to effect each selected analysis on said selected analysis data taking account of the respective positions of said selected network elements and to deliver in a cartographic form analysis results conforming to said selected type, with a view to use thereof by said network optimization and/or management and/or supervision system (OO).

2. A subsystem according to claim 1, characterized in that said interface (I) is adapted to define an analysis geographical area containing said selected network elements (Ci).

3. A subsystem according to claim 2, characterized in that said interface (I) is adapted to define an analysis geographical area as a function of a selected criterion.

4. A subsystem according to claim 3, characterized in that said criterion is selected from a group comprising a criterion of belonging to an area of predefined geometry within a region and a criterion of belonging to an environment of a selected type within a region.

5. A subsystem according to claim 2, characterized in that said analyzer means (MA) are adapted to effect each selected analysis on the selected analysis data relating to all the network elements (Ci) contained in said analysis geographical area.

6. A subsystem according to claim 1, characterized in that it further comprises first storage means (BD1) for storing data representing the geographical positions of the network elements (Ci) and said analyzer means (MA) are adapted to access said first storage means (BD1) to extract position data for the selected network elements with a view to effecting said analyses on said selected analysis data.

7. A subsystem according to claim 1, characterized in that it further comprises second storage means (BD2) for storing data defining analyses and said analyzer means (MA) are adapted to access said second storage means (BD2) to extract data defining at least some of the selected analyses with a view to effecting those analyses on said selected analysis data.

8. A subsystem according to claim 1, characterized in that said interface (I) is adapted to define at least some of the selected analyses and/or new analyses.

9. A subsystem according to claim 1, characterized in that at least some of said analyses are selected from a group comprising analysis of convergence and/or divergence of analysis data relative to reference data, analysis of the adequacy and/or inadequacy of capacities of network elements (Ci) as a function of observed traffic, analysis of interference between adjacent network elements, analysis of use of network elements (Ci) relative to a territory, and traffic flow analysis.

10. A subsystem according to claim 1, characterized in that some analysis results are delivered in the form of a list of objects for defining or refining sets of objects.

11. A network optimization and/or management and/or supervision system (OO) for use in a communications network including network elements (Ci) with known geographical positions through which passes traffic defined locally by analysis data, characterized in that it includes an analyzer subsystem (D) according to any one of the preceding claims.

12. A subsystem according to claim 11, characterized in that it is adapted to display analysis results delivered by said analyzer subsystem (D) to enable their visual use.

13. A subsystem according to claim 11, characterized in that it is adapted to define or refine sets of objects grouping each of the network elements (Ci) on the basis of the analysis results delivered by said analyzer subsystem (D).

14. A subsystem according to claim 11, characterized in that it is adapted to diagnose causes of problems occurring in said communications network from analysis results delivered by said analyzer subsystem (D).
